(19) United States
(12) Patent Application Publication
(10) Pub. No.: US 2019/0369713 A1
(43) Pub. Date: Dec. 5, 2019

(54) DISPLAY CONTROL APPARATUS, DISPLAY CONTROL METHOD, AND PROGRAM

(71) Applicant: SONY CORPORATION, TOKYO (JP)

(72) Inventors: RYUICHI SUZUKI, TOKYO (JP); TAKUYA IKEDA, TOKYO (JP); KENTARO IDA, TOKYO (JP); YOUSUKE KAWANA, TOKYO (JP); MAKI IMOTO, TOKYO (JP)

(21) Appl. No.: 16/334,119

(22) PCT Filed: Aug. 23, 2017
(86) PCT No.: PCT/JP2017/030145

§ 371 Date: Mar. 18, 2019

(30) Foreign Application Priority Data
Oct. 19, 2016 (JP) 2016-204951

(51) Int. Cl. G06F 3/01; G06F 3/00; G06F 3/14

(52) U.S. Cl. CPC G06F 3/011; G06F 3/1423; G06F 3/017; G06F 3/005

(57) ABSTRACT

[Object] To easily acquire the operation feeling of the object corresponding to an operating body.

[Solution] A display control apparatus according to the present disclosure includes: a first display control unit configured to control display of a first object corresponding to an operating body in a display region on the basis of a position of the operating body and a viewpoint position of a user; and a second display control unit configured to control display of a second object arranged toward a display position of the first object in the display region.

### TECHNICAL FIELD

The present disclosure relates to a display control apparatus, a display control method, and a program.

### BACKGROUND ART

Techniques for controlling display of various types of information on the basis of an operation detected by various sensors have been developed. For example, a technique for detecting a position or the like of an operating body such as a hand and controlling an output of information based on an obtained detection result to a screen or a display region of a display device such as a display is disclosed in Patent Literature 1.

### CITATION LIST

### Patent Literature

Patent Literature 1: WO 2015/098187

### DISCLOSURE OF INVENTION

### Technical Problem

For example, it is considered that an object operating in tandem with an operating body is caused to be displayed in the display region in order to improve the accuracy of the operation on the information displayed in the display region. However, when only the object is simply displayed, it is difficult to detect the tandem operation between the object and the operating body by a body sensation, and it takes time to have an operation feeling.

In this regard, the present disclosure proposes a display control apparatus, a display control method, and a program which are novel and improved and capable of easily acquiring an operation feeling of an object corresponding to an operating body.

### Solution to Problem

According to the present disclosure, there is provided a display control apparatus, including: a first display control unit configured to control display of a first object corresponding to an operating body in a display region on the basis of a position of the operating body and a viewpoint position of a user; and a second display control unit configured to control display of a second object arranged toward a display position of the first object in the display region.

In addition, according to the present disclosure, there is provided a display control method, including: controlling, by a processor, display of a first object corresponding to an operating body in a display region on the basis of a position of the operating body and a viewpoint position of a user; and controlling, by the processor, display of a second object arranged toward a display position of the first object in the display region.

In addition, according to the present disclosure, there is provided a program causing a computer to function as: a first display control unit configured to control display of a first object corresponding to an operating body in a display region on the basis of a position of the operating body and a viewpoint position of a user; and a second display control unit configured to control display of a second object arranged toward a display position of the first object in the display region.

### Advantageous Effects of Invention

As described above, according to the present disclosure, it is possible to easily acquire an operation feeling of an object corresponding to an operating body.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating an overview of a display control system 1 according to a first embodiment of the present disclosure.

FIG. 2 is a diagram illustrating a configuration example of a display control system 1 according to the embodiment.

FIG. 3 is a block diagram illustrating a functional configuration example of a control unit 100 according to the embodiment.

FIG. 4 is a diagram for describing an example of a display control method of a second object.

FIG. 5 is a diagram illustrating an example of control of display by a first display control unit 102 and a second display control unit 103.

FIG. 6 is a diagram illustrating an example of a state in which a user uses the display control system 1 according to the embodiment.

FIG. 7 is a flowchart illustrating an example of a flow of a process by a display control system 1 according to the embodiment.

FIG. 8 is a diagram for describing an example of control of a size of a first object.

FIG. 9 is a diagram for describing a first example of display control of a second object.

FIG. 10 is a diagram for describing a second example of display control of a second object.

FIG. 11 is a schematic diagram in which a space to which a display control system 1A according to a second embodiment of the present disclosure is applied is viewed from a side.

FIG. 12 is a schematic diagram in which a space to which a display control system 1A according to the embodiment is applied is viewed from above.

FIG. 13 is a diagram illustrating an example of control of display by a first display control unit 102 and a second display control unit 103.

FIG. 14 is a diagram illustrating an example of a state in which a plurality of users uses a display control system 1A according to the embodiment.

FIG. 15 is a diagram illustrating an example of a display displayed on a display region 41 illustrated in FIG. 14.

FIG. 16 is a diagram illustrating a first example of control of display positions of a plurality of objects by a second display control unit 103.

FIG. 17 is a diagram illustrating a second example of control of display positions of a plurality of objects by a second display control unit 103.

FIG. 18 is a diagram illustrating a first example of control of display forms of a plurality of objects by a second display control unit 103.

FIG. 19 is a diagram illustrating a second example of control of display forms of a plurality of objects by a second display control unit 103.

FIG. 20 is a diagram illustrating a third example of control of display forms of a plurality of objects by a second display control unit 103.

FIG. 21 describes a hardware configuration of an information processing apparatus 900 according to an embodiment of the present disclosure.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, the description will proceed in the following order.
1. First embodiment
1.1. Overview of display control system
1.2. Configuration example of control unit
1.3. Process example
1.4. Display control example
2. Second embodiment
2.1. Overview of display control system
2.2. Display control example
3. Hardware configuration example
4. Conclusion

### 1. First Embodiment

### 1.1. Overview of Display Control System

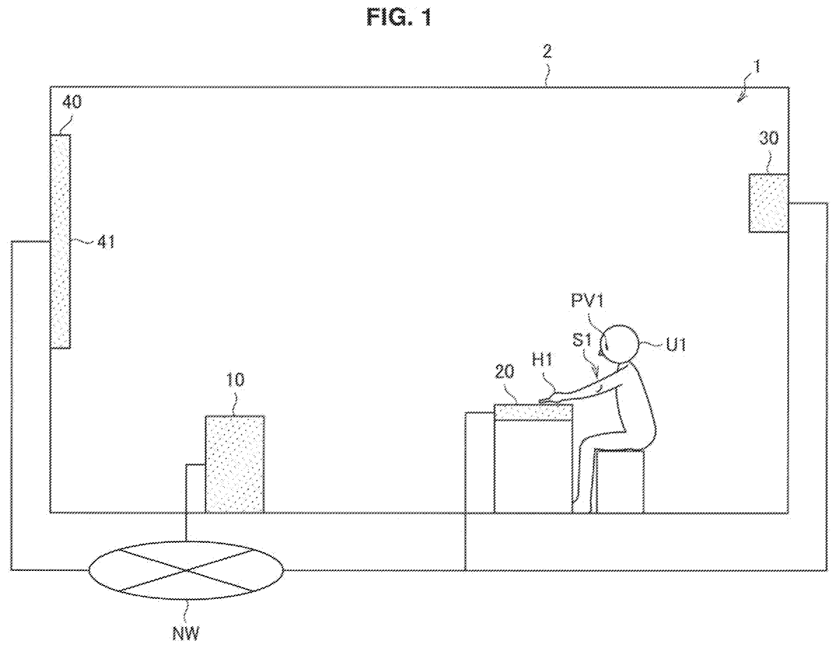

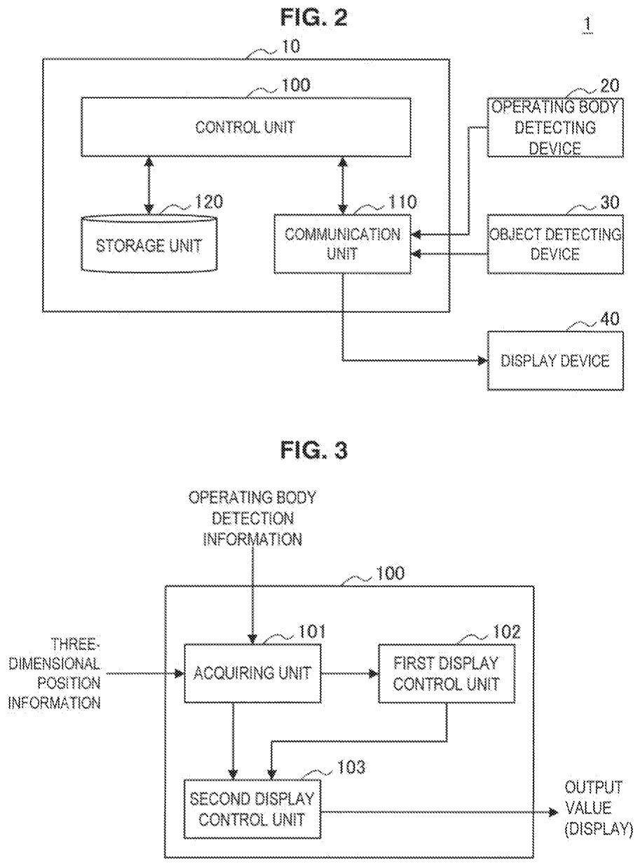

FIGS. 1 and 2 are diagrams illustrating an overview and a configuration example of a display control system 1 according to a first embodiment of the present disclosure. As illustrated in FIG. 1, the display control system 1 according to the present embodiment includes a display control apparatus 10, an operating body detecting device 20, an object detecting device 30, and a display device 40. The display control system 1 according to the present embodiment is applied to an arbitrary space (a space 2 in the present embodiment), acquires information related to an operation by a user U1 located in the space 2 using each detecting device, and performs control of display based on such detection information on the display device 40 that displays a predetermined screen.

### (Display Control Device)

The display control apparatus 10 is a device having a display control function for acquiring detection information obtained from each detecting device and performing control of display based on the detection information. The display control apparatus 10 may include a processing circuit, a storage device, a communication device, and the like. The display control apparatus 10 can be realized by any information processing device such as a personal computer (PC), a tablet, or a smartphone. Further, as illustrated in FIG. 1, the display control apparatus 10 may be realized by an information processing device arranged in the space 2 or may be realized by one or more information processing devices on a network as in cloud computing.

As illustrated in FIG. 2, the display control apparatus 10 includes a control unit 100, a communication unit 110, and a storage unit 120.

### (Control Unit)

The control unit 100 controls overall operation of the display control apparatus 10 according to the present embodiment. The function of the control unit 100 is realized by a processing circuit such as a central processing unit (CPU) included in the display control apparatus 10. Further, the control unit 100 has functions realized by respective functional units illustrated in FIG. 3 to be described later and plays a leading role in performing an operation of the display control apparatus 10 according to the present embodiment. The functions of the respective functional units included in the control unit 100 will be described later.

### (Communication Unit)

The communication unit 110 is a communication device included in the display control apparatus 10, and carries out various types of communications with an external device via a network (or directly) in a wireless or wired manner. The function of the communication unit 110 is realized by a communication device included in the display control apparatus 10. Specifically, the communication unit 110 is realized by a communication device such as a communication antenna and a radio frequency (RF) circuit (wireless communication), an IEEE 802.15.1 port and a transmission/reception circuit (wireless communication), an IEEE 802.11b port and a transmission/reception circuit (wireless communication), or a local area network (LAN) terminal and a transmission/reception circuit (wired communication). For example, as illustrated in FIG. 1, the communication unit 110 performs communication with the operating body detecting device 20, the object detecting device 30 and the display device 40 via a network NW. Specifically, the communication unit 110 acquires detection information from the operating body detecting device 20 and the object detecting device 30, and outputs information related to control of display generated by the control unit 100 to the display device 40. Further, the communication unit 110 may perform communication with other devices not illustrated in FIGS. 1 and 2.

### (Storage Unit)

The storage unit 120 is a storage device included in the display control apparatus 10, and stores information acquired by the communication unit 110, information obtained by processes of the respective functional units of the control unit 100, and the like. The storage unit 120 is realized by, for example, a magnetic recording medium such as a hard disk, a non-volatile memory such as a flash memory, or the like. For example, the storage unit 120 may store information related to a body of the user using the display control system 1 (a line of sight position PV1 or the like). Further, the storage unit 120 appropriately outputs stored information in response to a request from each functional unit included in the control unit 100 or from the communication unit 110. Further, the storage unit 120 need not necessarily be included in the display control apparatus 10, and for example, the function of the storage unit 120 may be realized by an external cloud server or the like.

### (Operating Body Detecting Device)

The operating body detecting device 20 is an example of a detecting device used for detecting the operating body. The operating body detecting device 20 according to the present embodiment generates operating body detection information related to a hand H1 of the user U1 which is an example of the operating body. The generated operating body detection information is output to the display control apparatus 10 via the network NW (or directly). Further, as illustrated in FIG. 1, for example, the operating body detecting device 20 according to the present embodiment detects the hand H1 which can be positioned above the operating body detecting device 20 installed on a workbench.

The operating body detection information includes, for example, information (three-dimensional position information) related to a position of the detected operating body in a three-dimensional space. In the present embodiment, the operating body detection information includes three-dimensional position information of the operating body in a coordinate system of the space 2. Further, the operating body detection information may include a model or the like generated on the basis of a shape of the operating body. As described above, the operating body detecting device 20 generates information related to an operation which the user performs on the operating body detecting device 20 as the operating body detection information.

The operating body detecting device 20 according to the present embodiment can be realized by an infrared irradiation light source, an infrared camera, and the like. Further, the operating body detecting device 20 may be realized by any of various types of sensors such as, for example, a depth sensor, a camera, a magnetic sensor, and a microphone. In other words, the operating body detecting device 20 is not particularly limited as long as it can acquire a position, a form, or the like of the operating body.

Further, in the example illustrated in FIG. 1, the operating body detecting device 20 is described as being placed on the workbench, but the present technology is not limited to such an example. For example, in another embodiment, the operating body detecting device 20 may be a device held by a hand which is an operating body or a wearable device which is attached to a wrist, an arm or the like. Various types of inertial sensors or mechanical sensors such as a gyro sensor, a potentiometer, and an encoder are installed in such a wearable device, and a position, a form, or the like of a hand which is the operating body may be detected by each sensor. Further, in another embodiment, a marker may be installed on the hand of the user, and the operating body detecting device 20 may detect the position, the form, or the like of the hand by recognizing such a marker. Further, the form of the hand is, for example, a type of hand (a left hand or a right hand), a direction of a hand or a finger, a gesture indicated by a shape of the hand (for example, a gesture forming a ring with the thumb and the index finger or a gesture forming “scissors” by extending only the index finger and the middle finger), or the like. The detection of the form of the hand can be realized by a known detection technique. Further, the operating body detecting device 20 may be a device which generates the operating body detection information using a touch of a hand as an input such as a touch panel.

Further, in the present embodiment, the hand is assumed as an example of the operating body, but the present technology is not limited to such an example. The operating body may be, for example, a finger of the hand of the user or a foot of the user. Further, the operating body may be an object used by the user to operate an operation target such as a device gripped by the user (for example, a dish, a laboratory instrument, a medical instrument, or a tool).

### (Object Detecting Device)

The object detecting device 30 is an example of a detecting device used for estimating the position or the like of the user. The object detecting device 30 according to the present embodiment generates three-dimensional position information of a detected body. The generated three-dimensional position information is output to the display control apparatus 10 via the network NW (or directly). Further, as illustrated in FIG. 1, for example, the object detecting device 30 according to the present embodiment is installed at a position (a ceiling or a wall) at which the user U1 can be detected in the space 2 in which the display control system 1 is used.

The object detecting device 30 according to the present embodiment can be realized by a depth sensor. Further, the object detecting device 30 may be realized by, for example, a stereo camera or the like. Further, the object detecting device 30 may be realized by a sensor capable of performing distance measurement using an infrared sensor, a time of flight (TOF) type sensor, an ultrasonic sensor, or the like or may be realized by a device which projects an IR laser pattern. In other words, the object detecting device 30 is not particularly limited as long as it can detect the body or the like of the user in the space.

Further, although the object detecting device 30 is described as being arranged on the ceiling, the wall, or the like of the space 2 in the example illustrated in FIG. 1, the present technology is not limited to such an example. For example, in another embodiment, the object detecting device 30 may be a wearable device worn on the head, the arm, or the like of the user. Various types of inertial sensors or mechanical sensors such as a gyro sensor, a potentiometer, and an encoder are installed in such a wearable device, and a position or the like of the head, the upper limb, or the like of the user may be detected directly by each sensor. Further, in another embodiment, a marker may be installed on the head or the upper limb of the user, and the object detecting device 30 may directly detect the body or the like of the user by recognizing such a marker.

Further, in another embodiment, the display control system 1 may include a device capable of detecting a position of each part of the body of the user such as a viewpoint position of the user instead of the object detecting device 30. Such a device may be realized by, for example, an image recognition sensor or the like capable of identifying the head, the arm, the shoulder (hereinafter collectively referred to as an “upper limb”), or the like of the user by image recognition or the like.

### (Display Device)

The display device 40 is a device which is arranged in the space 2 to which the display control system 1 is applied, and displays a predetermined screen and information output from the display control apparatus 10 via the network NW (or directly) in a display region 41. Although the details will be described later, the display in the display region 41 of the display device 40 according to the present embodiment is controlled by the display control apparatus 10.

For example, as illustrated in FIG. 1, the display device 40 according to the present embodiment can be realized by a display device such as a liquid crystal display or an organic electro luminescence (EL) display which is arranged on the wall of the space 2 to which the display control system 1 is applied, but the present technology is not limited to such an example. For example, the display device 40 may be a fixed display device which is fixedly installed at an arbitrary position of the space 2. Further, the display device 40 may also be a portable display device having a display region such as a tablet, a smartphone, or a laptop PC. In a case in which the portable display device is used without being fixed, it is desirable if position information of such a portable display device can be acquired. Further, the display device 40 may be a projection type display device which sets a display region in an arbitrary wall body and projects a display onto the display region such as a projector. Further, a shape of such a display region is not particularly limited. Further, such a display region is not limited to a flat surface but may be a curved surface, a spherical surface, or the like.

In the display control system 1, the operating body detecting device 20 detects the position or the like of the hand H1 of the user U1 which is an example of the operating body, the object detecting device 30 detects a skeleton of the user U1, and the detection information is output to the display control apparatus 10. On the basis of the detection information, the display control apparatus 10 controls display of a virtual object corresponding to the operating body such as the hand H1 in the display region. Accordingly, the user U1 can perform an operation on a screen displayed in the display region while looking at the virtual object corresponding to his/her hand H1 reflected on the screen.

However, it is not easy to recognize that the virtual object corresponding to the hand H1 of the user U1 operates in tandem with his/her own hand H1. For example, even when the virtual object is displayed on the screen displayed in the display region, the virtual object corresponding to the hand H1 is searched for through learning by moving the hand H1 or the like, and it is difficult to recognize the virtual object corresponding to one's own hand H1 intuitively.

In this regard, the present disclosure proposes technology that enables the virtual object corresponding to the operating body to be intuitively recognized. Specifically, in the present disclosure, a technique of controlling display of a second object such that a virtual object (second object) different from a virtual object (first object) is arranged to face a display position of the first object displayed in the display region. The second object may be, for example, an object corresponding to an arm S1 of the user U1, but the second object and the arm S1 need not necessarily operate in tandem with each other. With such a technique, it is possible to more easily detect the virtual object corresponding to the hand H1 of the user U1 in the screen displayed in the display region by display of the second object corresponding to the arm S1 of the user U1. Therefore, the operation feeling in the operation screen can be easily acquired.

Hereinafter, the display control system 1 according to the present embodiment will be described in detail.

### 1.2. Configuration Example of Control Unit

Next, an example of a configuration and a function of the control unit 100 according to the first embodiment of the present disclosure will be described. FIG. 3 is a block diagram illustrating a functional configuration example of the control unit 100 according to the present embodiment. Referring to FIG. 3, the control unit 100 includes an acquiring unit 101, a first display control unit 102, and a second display control unit 103.

### (Acquiring Unit)

The acquiring unit 101 has a function of acquiring position information of the user using the display control system 1. The position information of the user is not limited to information of the position of the user and includes position information of each part of the body of the user. The position information of each part of the body of the user includes, for example, position information of the hand H1 of the user U1, information of the viewpoint position PV1 of the user U1, position information of the upper arm (for example, the arm S1) of the user U1, and the like illustrated in FIG. 1.

Further, the information of the position of the user here means a representative position within the space 2 of the user using the display control system 1. Therefore, the information of the position of the user may be information obtained independently of the position information of each part of the user, may be identical to the position information of each part, or may be information of a position estimated on the basis of any of those positions. For example, the position of the user may be a position of the hand of the user (that is, the position of the operating body), may be the position of the viewpoint position of the user or the position of the upper limb of the user, or may be a position estimated on the basis of any of those positions.

Here, the upper limb of the user is an example of a supporting body in the present disclosure. The supporting body is associated with the operating body and supports the operating body, and corresponds to the upper limb for the hand.

The acquiring unit 101 according to the present embodiment can first acquire the position information of the hand of the user which is the operating body using the operating body detection information generated by the operating body detecting device 20. Specifically, the acquiring unit 101 can estimate the position of the hand of the user on the basis of the detection position of the operating body included in the operating body detection information and generate the position information of the hand of the user.

Further, in another embodiment, instead of the acquiring unit 101, the operating body detecting device 20 may calculate the position of the hand of the user, and the acquiring unit 101 may acquire the position information of the hand of the user.

Further, the acquiring unit 101 may acquire information related to the shape of the hand of the user using the operating body detection information. Specifically, the acquiring unit 101 can calculate the shape of the hand of the user on the basis of a model of the operating body included in the operating body detection information and generate shape information of the hand of the user. The shape information of the hand can be used, for example, for control of a display form of the first object.

Further, the acquiring unit 101 according to the present embodiment can acquires the position of the user, the viewpoint position of the user, and the position information of the upper limb of the user using the three-dimensional position information generated by the object detecting device 30. Specifically, the acquiring unit 101 may identify the body of the user which is a detected body from the three-dimensional position information, generate the skeleton information of the user, estimate the viewpoint position or the like of the user from the skeleton information, and generate each piece of position information. Further, the viewpoint position of the user can be estimated, for example, from a position of a part corresponding to the head in the skeleton of the user. A known skeleton estimation engine or the like may be used for the detection of the skeleton of the user.

Here, the viewpoint position of the user according to the present embodiment means, for example, a position corresponding to the eye of the user using the display control system 1. The viewpoint position of that user may be acquired by directly measuring the position of the eye of the user or may be acquired by estimating it on the basis of the position of the body of the user, a direction of a line of sight, or the like. Further, for example, the viewpoint position of the user may be a part corresponding to the head, the upper body, or the like of the user in addition to the eye of the user as described above. The viewpoint position of the user in the display control system 1 can be defined by a coordinate system based on an arbitrary component in the space 2. For example, the viewpoint position of the user may be defined by relative coordinates of the eye (or the head) of the user in the coordinate system based on the display region of the display device 40. Alternatively, the viewpoint position of the user in the display control system 1 may be defined by absolute coordinates of the eye (or the head) of the user in a global coordinate system indicating the space 2 in which the display control system 1 is used.

Further, in another embodiment, instead of the acquiring unit 101, the object detecting device 30 may generate the skeleton information of the user from the three-dimensional position information and estimate the position of the viewpoint position or the like of the user. In this case, the acquiring unit 101 may acquire each piece of position information from the object detecting device 30.

Further, as illustrated in FIG. 1, in a case in which the user U1 sits at a predetermined location and uses the display control system 1, the position of the user U1 except the hand H1 can generally be fixed. Therefore, at least one of the viewpoint position of the user and the position of the upper limb of the user may be acquired using skeleton information stored in the storage unit 120 in advance. The skeleton information stored in the storage unit 120 may be standard skeleton information corresponding to the skeletons of all users or may be skeleton information assigned to the user using the display control system 1. In this case, the object detecting device 30 need not be necessarily installed in the display control system 1 described above.

The acquiring unit 101 outputs information related to the obtained viewpoint position of the user and the position of the hand to the first display control unit 102. Further, the acquiring unit 101 outputs information related to the acquired position of the user and the position of the upper limb of the user to the second display control unit 103.

### (First Display Control Unit)

The first display control unit 102 has a function of controlling display of the virtual object (first object) corresponding to the operating body.

The first display control unit 102 according to the present embodiment controls the display of the first object corresponding to the hand of the user which is the operating body in the display region 41 of the display device 40. For example, the first display control unit 102 controls the display of the first object in the display region 41 on the basis of the viewpoint position of the user and the position of the hand. More specifically, the first display control unit 102 performs control such that the first object is displayed at a position at which an extension line of the line of sight in a case in which the user views the hand from his/her viewpoint intersects with the display region 41. Accordingly, in a case in which the user views his/her hand, the user can have a feeling as if his/her hand were immersed into the screen displayed in the display region 41.

More specifically, the first display control unit 102 calculates a display position of the first object in the display region 41 on the basis of the three-dimensional position information of the viewpoint position of the user and the hand position and information of the shortest distance between the display region 41 and the hand (or the viewpoint). Further, in a case in which the calculated display position of the first object is outside the display region 41, the first display control unit 102 may not display the first object. Further, the shortest distance between the display region 41 and the hand (or the viewpoint) may be a previously acquired predetermined value or a value obtained by measuring a distance with the object detecting device 30, another sensor, or the like.

Further, the first display control unit 102 may cause a display form of the first object corresponding to the hand of the user to be changed on the basis of information related to the shape of the hand of the user. For example, the first display control unit 102 may cause the display form of the first object to be changed on the basis of a motion and a form of the hand estimated on the basis of the information related to the shape of the hand of the user. The change of the display form of the first object may include causing a structure of the first object to be changed and causing a different object to be added to the first object. For example, in a case in which the first object imitates an object of a hand, the first display control unit 102 may cause the object of the hand to be changed to a different object (such as an object of a hand of an animal) or cause a pointer to be added to the object of the hand. Accordingly, it is possible to increase variations of the operation by the first object and to perform a free operation on the screen displayed in the display region 41.

### (Second Display Control Unit)

The second display control unit 103 has a function of controlling display of the virtual object (second object) arranged to face the display position of the first object.

For example, the second object is arranged to extend toward the display position of the first object in the display region 41. Since the second object associated with the first object corresponding to the hand is displayed as described above, not only the hand of the user but also the object corresponding to the arm is expressed. In this case, a feeling as if the hand and the arm of the user were present in the screen displayed in the display region 41 is obtained. Therefore, the user can easily acquire the operation feeling for the screen displayed in the display region 41. Therefore, an initial learning load of the operation by the first object can be reduced.

Further, the second display control unit 103 according to the present embodiment may control the display of the second object on the basis of the position of the user. More specifically, the second display control unit 103 may control the display position of the second object on the basis of the position of the user. For example, in a case in which the user is assumed to be located on the left side toward the display region 41, the second display control unit 103 may display the second object in the region on the left side of the display region 41. Accordingly, it is possible to obtain a feeling as if the second object is extended from a position at which the user is located. Therefore, the operation feeling of the first object can be acquired more easily.

Further, as will be described in detail in a second embodiment, as the second object is displayed on the basis of the position of the user, in a case in which a plurality of users performs operations on a screen displayed on a single display region 41, the second object is displayed at the display position corresponding to the position of the user. Therefore, the user can identify the first object corresponding to his/her hand immediately. Therefore, since a possibility of confusion between the first object corresponding to his/her hand and another object in the screen displayed in the display region 41 is reduced, the operability is further improved.

Further, the second object according to the present embodiment may be, for example, a virtual object corresponding to the supporting body. The supporting body is an object for supporting the operating body, and specifically, the supporting body corresponds to the upper limb such as the arm or the shoulder for the hand of the user. As the second object corresponding to the supporting body is displayed, the feeling as if the arm of the user were immersed into the display region 41 can be obtained, and thus the operability can be further improved.

The second display control unit 103 may control the display of the second object on the basis of, for example, the position of the supporting body. Here, the position of the supporting body is, for example, a representative position of the upper limb of the user, and more specifically, the position of the supporting body may be an elbow, a base of an arm, a shoulder, or the like. The position of the supporting body is obtained on the basis of, for example, the skeleton information. As the display of the second object (more specifically, the display position) is controlled on the basis of the position of the supporting body, it is possible to cause the display of the second object in the display region 41 to be reflected on the state of the upper limb of the user which actually performs an operation. Therefore, since his/her own upper limb and the second object operate in tandem with each other, the operability of the user can be further improved.

Further, the second display control unit 103 may control the display of the second object on the basis of a relation between the position of the supporting body and the display position of the first object in the display region 41.

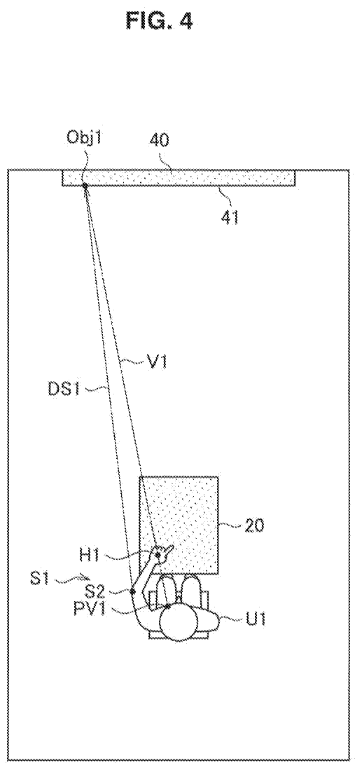

FIG. 4 is a diagram for describing an example of a display control method of the second object. Referring to FIG. 4, first, the first display control unit 102 causes a first object Obj1 to be displayed at an intersection point of an extension line V1 of the viewpoint position PV1 of the user U1 and the position of the hand H1 and a plane formed by the display region 41 of the display device 40. In this case, in order to easily recognize that the object corresponding to the hand H1 of the user U1 is the first object Obj1, it is desirable that the second object corresponding to the arm extending from the base of the first object Obj1 corresponding to the hand H1 of the user U1 who views the display region 41 be extended toward the base of the arm of the user U1 and displayed.

In this regard, the second display control unit 103 performs control such that the second object is displayed to extend from the first object Obj1 in the display region 41 toward a representative position S2 (for example, the elbow) of an arm S1 of the user U1 as illustrated in FIG. 4. In other words, the second display control unit 103 controls the display of the second object in the display region 41 such that that the arm is virtually positioned on an extension line DS1 of the arm extending from the first object Obj1 to the representative position S2. Such control is realized by using the display position of the first object Obj in the display region 41 and the position of the arm S1 (the representative position S2). Accordingly, it is possible to give the user U1 a feeling as if the second object extends from the actual arm S1 of the user U1. Therefore, the operability of the first object by the user U1 can be further improved.

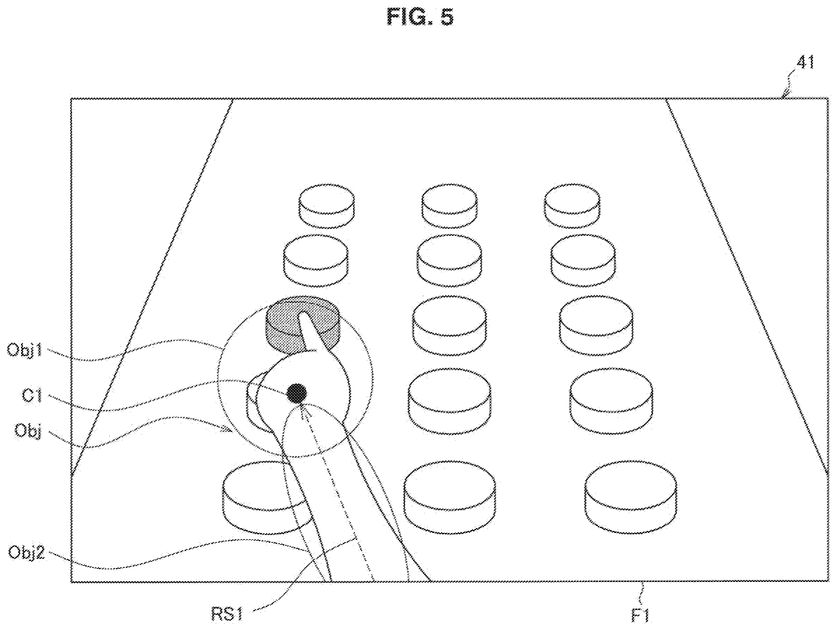

Here, an example of control of display in the display region 41 for the display device 40 by the first display control unit 102 and the second display control unit 103 will be described. FIG. 5 is a diagram illustrating an example of control of display by the first display control unit 102 and the second display control unit 103. As illustrated in FIG. 5, a screen indicating a virtual reality (VR) space (virtual space) is displayed in the display region 41. Such a VR space is an example of the screen displayed in the display region 41. The user performs a predetermined operation on an operation target virtually arranged in the VR space. Virtual objects (hereinafter referred to as operation objects) Obj imitating the hand and the arm of the human body for performing a predetermined operation are displayed on the screen indicating the VR space. The user performs a predetermined operation on the operation target by the operation object Obj through a hand motion.

The operation object Obj is integrally formed by a first object Obj1 corresponding to the hand and a second object Obj2 corresponding to the arm. In particular, since the operation object Obj illustrated in FIG. 5 imitates the hand and the arm of the user, the first object Obj1 and the second object Obj2 are seamlessly coupled. Accordingly, it is possible to reduce a sense of discomfort for the user who views the display region 41.

As illustrated in FIG. 5, the second object Obj2 is arranged to extend from a contour F1 in a lower part of the display region 41 toward a display position C1 of the first object Obj1. The second object Obj2 may be arranged to extend towards the display position C1 along a line RS1.

The line RS1 may be, for example, a line obtained by projecting the extension line DS1 of the arm illustrated in FIG. 4 onto the display region 41. As the second object Obj2 is arranged along the line RS1, it is possible to give the user a feeling as if his arm is immersed into the screen displayed in the display region 41.

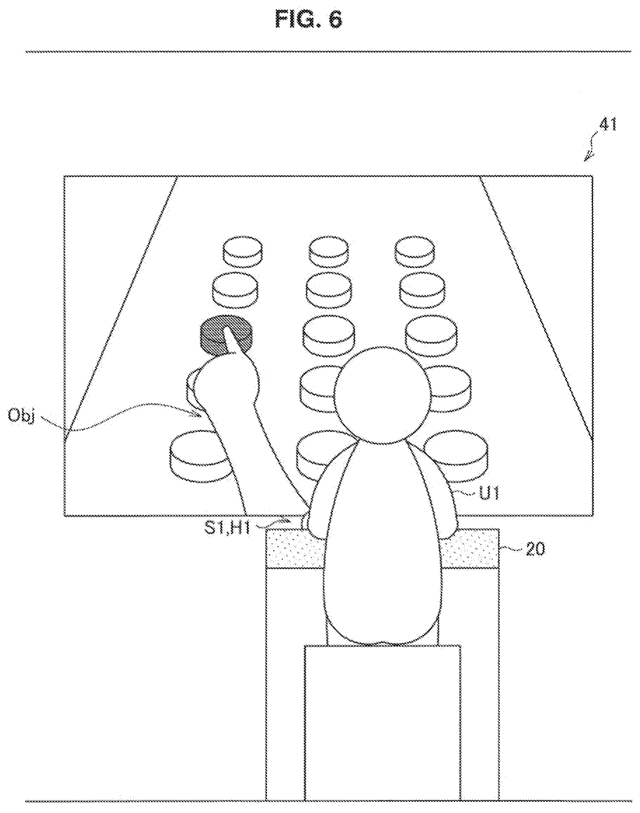

FIG. 6 is a diagram illustrating an example of operational effects of the display control system 1 according to the present embodiment. As illustrated in FIG. 6, the operation object Obj in the screen displayed in the display region 41 is displayed on the extension line of the hand H1 and the arm S1 of the user U1. Therefore, the user U1 viewing the display region 41 can get a feeling as if the user is looking at his/her hand. Therefore, it is possible to intuitively identify the operation object Obj which operates in tandem with his/her hand H1. For example, even in a case in which the user U1 looks at the display region 41 again after turning his eyes from the display region 41, the user U1 can immediately operate the operation object Obj corresponding to his/her hand H1.

Further, an arrangement position of the second object Obj2 is not limited to the above example. For example, in the example illustrated in FIG. 5, it may extend from a predetermined position of the contour F1 of the display region 41 toward the display position C1 or may extend from a position within the display region 41 corresponding to a position of the user within the space 2 toward the display position C1. Further, as will be described in detail later, the second object Obj2 is not limited to a linear shape and may have a curved shape. Further, the second object Obj2 may be constituted by a plurality of operation objects.

Further, although the operation object Obj illustrated in FIG. 5 imitates the hand and the arm of the human body, the display form of the operation object Obj is not limited to this example. The display form of the operation object Obj is not particularly limited as long as it is possible to recognize a motion or the like by the operating body of the user which is an operating entity in the screen displayed in the display region 41.

Further, as illustrated in FIG. 5, it is desirable to display the screen of the VR space in the display region 41 in association with an angle at which the VR space is overlooked from the viewpoint position of the user. Specifically, it is desirable to display the VR space in association with an angle at which an overhead view similar to that in a case in which his/her hand is viewed from the viewpoint position of the user is obtained. Accordingly, it is possible to further reduce a sense of discomfort between the operation by hand and an operation within the VR space. Such a screen display may be controlled on the basis of, for example, a relation between the viewpoint position of the user and the position of the hand, a distance between the viewpoint position of the user and the display region 41, or the like.

### 1.3. Process Example

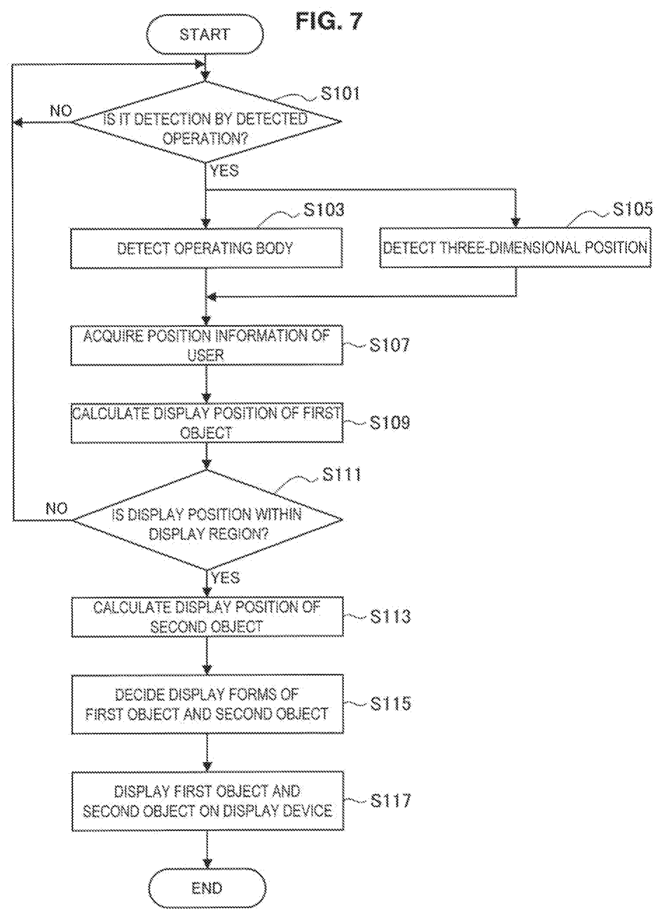

Next, an example of a flow of a process by the display control system 1 according to the present embodiment will be described with reference to FIG. 7. FIG. 7 is a flowchart illustrating an example of a flow of a process by the display control system 1 according to the present embodiment. Further, since a process of each step is a process based on content described above, detailed description thereof will be omitted.

Referring to FIG. 7, firstly, the operating body detecting device 20 detects an operation by hand which is the operating body (step S101). If the operating body detecting device 20 detects an operation by hand (YES in S101), the operating body detecting device 20 detects the position of the hand or the like (step S103). At this time, the object detecting device 30 generates the three-dimensional position information of the detected object which is detected at the same time (step S105).

Then, the acquiring unit 101 acquires the position information such as the viewpoint position of the user, the position of the hand, the position of the upper limb, or the like on the basis of the operating body detection information and the three-dimensional position information (step S107). Then, the first display control unit 102 calculates the display position in the display region of the first object on the basis of the viewpoint position of the user, the hand position, or the like (step S109). If the calculated display position is within the display region (YES in step S111), the second display control unit 103 calculates the display position of the second object (step S113).

Then, the first display control unit 102 and the second display control unit 103 decide the display forms of the first object and the second object (step S115). Further, the process of step S115 will be described later in detail. Then, the first display control unit 102 and the second display control unit 103 control the display of the first object and the second object for the display device 40 (step S117).

The display control system 1 sequentially repeats the processes in accordance with steps S101 to S117 until the process ends.

The example of the flow of the process of the display control system 1 according to the present embodiment has been described above.

### 1.4. Display Control Example

Next, an example of display control in the display control system 1 according to the present embodiment will be described.

### (1) Control of Size of First Object

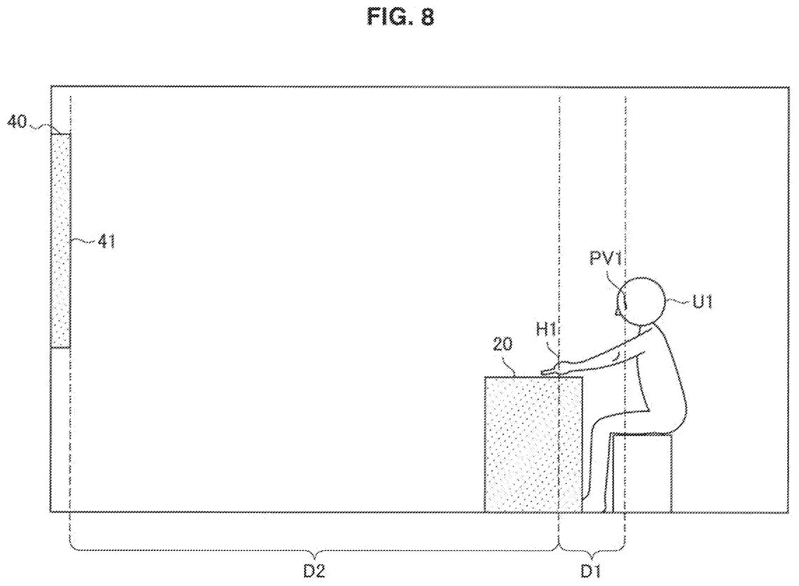

FIG. 8 is a diagram for describing an example of control of the size of the first object. As illustrated in FIG. 8, the first display control unit 102 may control the size of the first object on the basis of a relation between the viewpoint position PV1 of the user U1, the position of the hand H1, and the position of the display region 41. Accordingly, it is possible to cause the size of the hand H1 located on the operating body detecting device 20 viewed from the viewpoint position PV1 to be equal to the size of the first object displayed in the display region 41 viewed from the viewpoint position PV1. As the display is performed such that the size of the first object viewed from the viewpoint position PV1 is equal to the actual size of the hand H1, it is possible to give a feeling as if the user U1 viewing the display region 41 moves the hand H1 within the screen displayed in the display region 41.

More specifically, as illustrated in FIG. 8, a relation of the respective positions means a relation based on a horizontal distance D1 between the viewpoint position PV1 and the position of the hand H1 and a horizontal distance D2 between the position of the hand H1 and the display region 41. In this case, it is desirable that the size of the first object in the display region be set to be (D1+D2)/D1 times as large as the actual size of the hand H1. Accordingly, the first object can be displayed with the same size as that of the hand H1 when viewed from the viewpoint position PV1.

### (2) Display Control for Second Object

In the example illustrated in FIG. 5, the second object Obj2 is arranged to extend from the contour F1 in the lower part of the display region 41 to the display position C1 of the first object Obj1, but the display control for the second object is not limited to this example. Further, the “display control” here includes “control of display form” in addition to “control of display position.” The display form may include, for example, a size and a shape of the display of the operation object, a height in the VR space, a display effect (including a sequential change or the like), and the like.

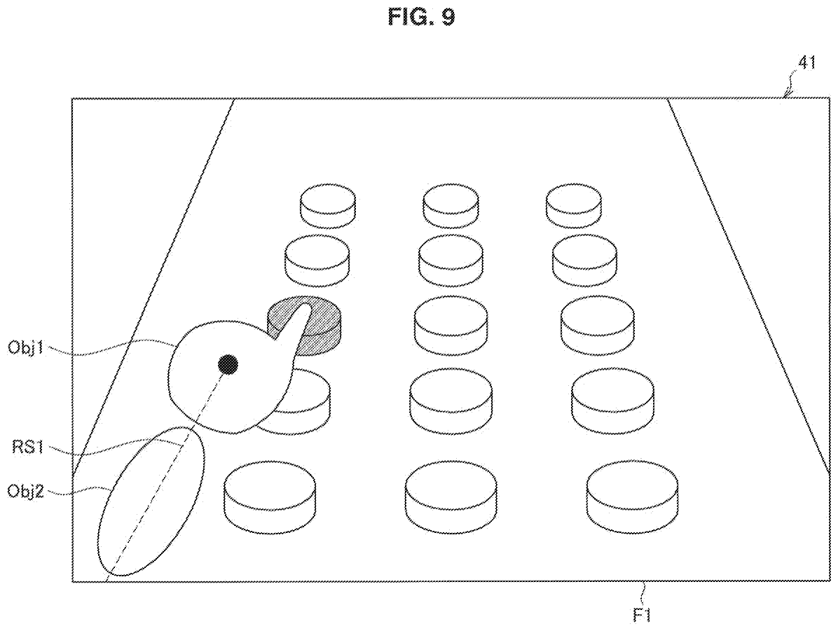

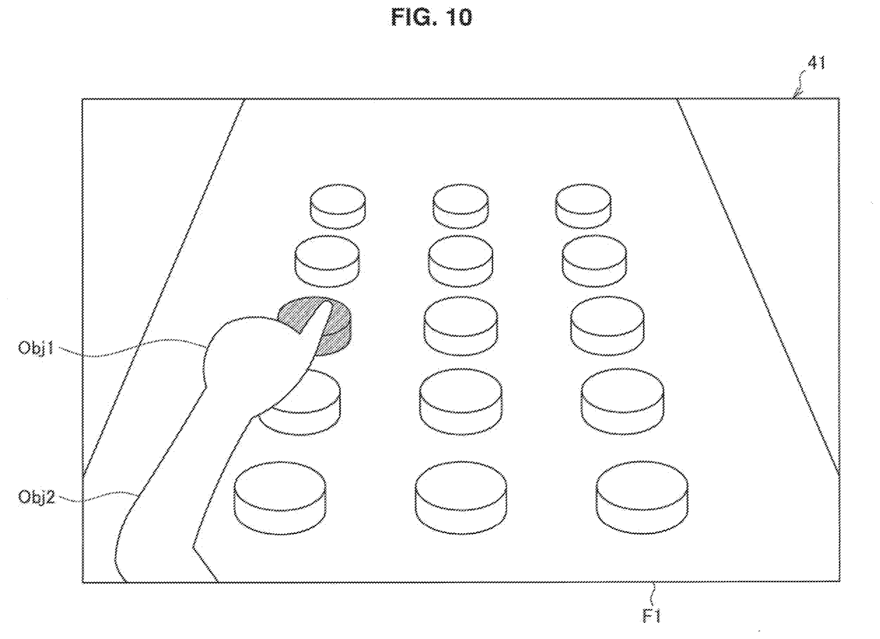

FIGS. 9 and 10 are diagrams for describing a first example and a second example of the display control for the second object. First, referring to FIG. 9, in the display region 41, the second object Obj2 is arranged along the line RS1 toward the display position of the first object Obj1. Here, the second object Obj2 is in a state in which it does not comes into contact with any of the first object Obj1 and the contour F1. In this state, it is possible to give a feeling as if his/her hand is immersed into the screen displayed in the display region 41.

Next, referring to FIG. 10, in the display region 41, the second object Obj2 is arranged toward the display position of the first object Obj1 with a shape in which it is bent at a part corresponding to the elbow. For example, display of the second object Obj2 having such a shape can be controlled by acquiring position information of a plurality of positions such as the elbow in the upper limb which is the supporting body. Accordingly, since it is possible to express the second object Obj2 corresponding to the upper limb more realistically, the visibility of the user for the first object Obj1 can be improved.

Further, in addition to the example of the display control illustrated in FIGS. 9 and 10, the control of the display position and the display form is not particularly limited as long as the second object Obj2 is arranged toward the display position of the first object Obj1.

The display control system 1 according to the first embodiment of the present disclosure has been described above.

### 2. Second Embodiment

Next, a display control system 1A according to the second embodiment of the present disclosure will be described. The display control system 1A according to the present embodiment controls display of operation objects respectively corresponding to the hands of a plurality of users.

### 2.1. Overview of Display Control System

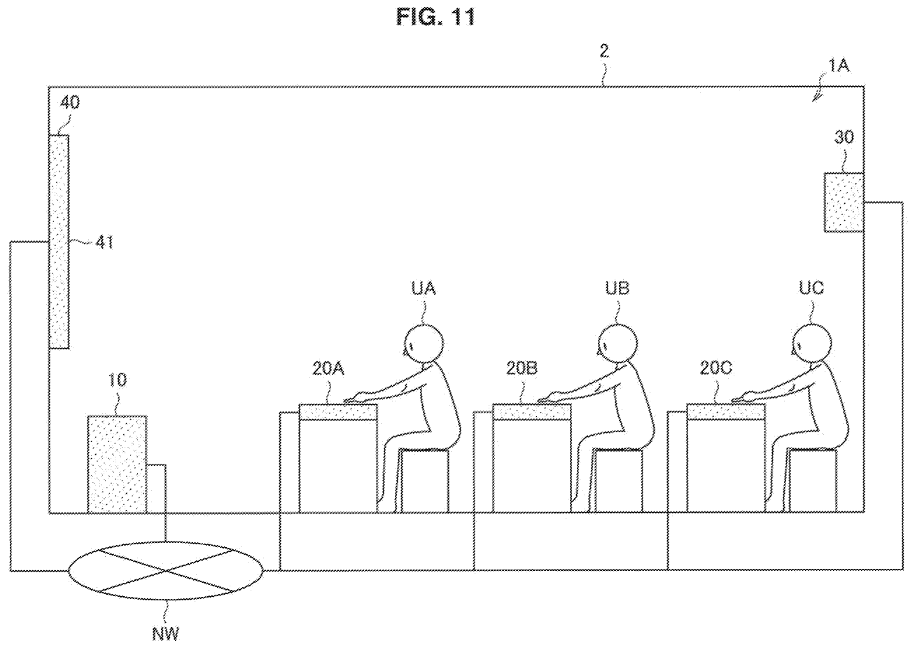

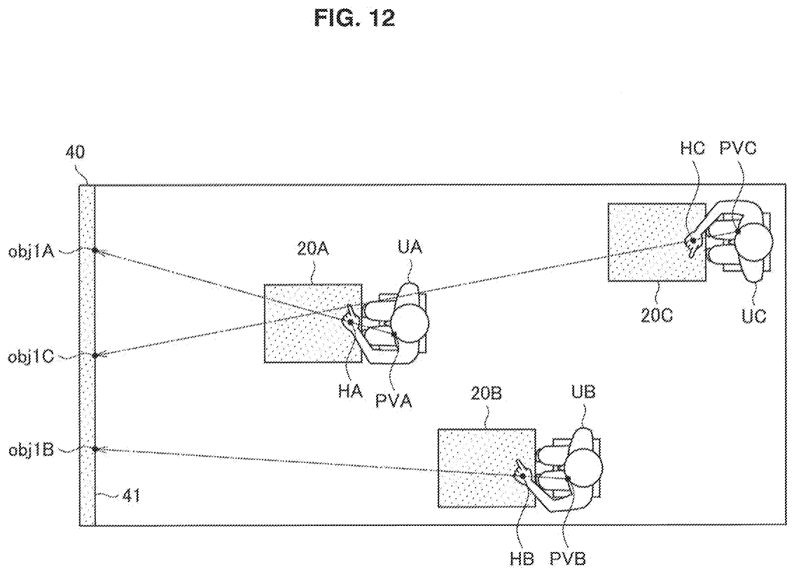

FIGS. 11 and 12 are diagrams illustrating an overview of the display control system 1A according to the second embodiment of the present disclosure. FIG. 11 is a schematic diagram in which a space 2 to which the display control system 1A according to the present embodiment is applied is viewed from a side, and FIG. 12 is a schematic diagram in which the space 2 to which the display control system 1A according to the present embodiment is applied is viewed from above. Further, the display control system 1A according to the present embodiment similar to the display control system 1 according to the first embodiment in a configuration and a function except that a plurality of operating body detecting devices 20A, 20B, and 20C are installed in association with a plurality of users UA, UB, and UC. Therefore, description of functions of respective components of the display control system 1A is omitted.

As illustrated in FIG. 11, in the display control system 1A according to the present embodiment, a plurality of users UA to UC perform operations by hand which is the operating body on a screen displayed on a single display region 41 through the operating body detecting devices 20A, 20B, and 20C. Further, the display control apparatus 10 according to the present embodiment acquires position information of the respective users UA to UC using the operating body detection information obtained by the operating body detecting devices 20A to 20C and the three-dimensional position information obtained by the object detecting device 30, and controls display of objects corresponding to the hands of the respective users UA to UC in the display region 41.

Specifically, as illustrated in FIG. 12, the first display control unit 102 control display of first objects Obj1A to Obj1C corresponding to hands HA to HC of the respective users UA to UC on the basis of viewpoint positions PVA to PVC of the respective users UA to UC and positions of the respective hands HA to HC in the display region 41. A control process for such display is similar to that of the first embodiment. In this case, the respective users are positioned toward the display region 41 in the order of the users UB, UA, and UC from the left side, while the first objects are positioned toward the display region 41 in the order of the first objects Obj1B, Obj1C, and Obj1A from the left side. In this case, for example, since the positions of the user UA and the user UC and the positions of the first objects corresponding to the respective hands are switched, it is difficult for the user UA and the user UC to identify the first objects corresponding to their hands.

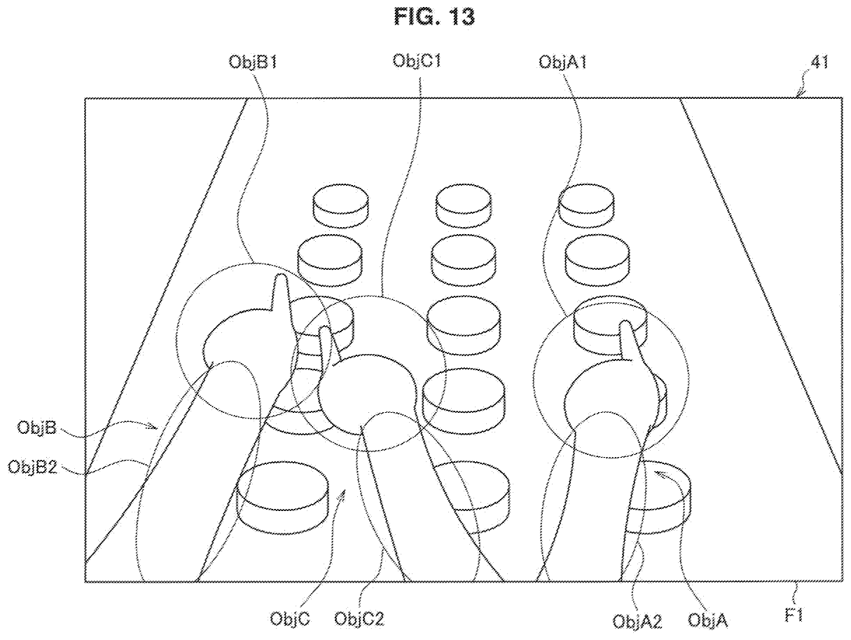

In this regard, the second display control unit 103 controls an arrangement of second objects Obj2A to Obj2C such that the second objects Obj2A to Obj2C face the display positions of the first objects Obj1A to Obj1C, respectively. FIG. 13 is a diagram illustrating an example of control of display by the first display control unit 102 and the second display control unit 103. As illustrated in FIG. 13, a screen illustrating a VR space used for VR content which is an example of content is displayed in the display region 41, and operation objects ObjA to ObjC imitating the hands and the arms of the users UA to UC are displayed. The operation objects ObjA to ObjC are constituted by the first objects Obj1A to Obj1C corresponding to the hands and the second objects Obj2A to Obj2C corresponding to the arms, respectively

In the present embodiment, display of the second objects Obj2A to Obj2C is controlled on the basis of the positions of the respective users UA to UC. In other words, the second display control unit 103 controls the display positions of the second objects Obj2A to Obj2C on the basis of the positions of the users UA to UC. More specifically, the second display control unit 103 performs the display so that the second objects Obj2A to Obj2C are positioned on the extension lines of the extended hands and the extended arms of the users UA to UC on the basis of the viewpoint positions PVA to PVC of the users UA to UC, the positions of the hand HA to HC, and the positions of the upper limbs. Accordingly, the users UA to UC can intuitively identify the first objects Obj1A to Obj1C corresponding to their hands. In other words, even in a case in which a plurality of users performs operations on the screen on the single display region 41, a plurality of users can immediately understand the operation objects corresponding to their hands.

### 2.2. Display Control Example

Incidentally, in a case in which a plurality of users performs operations at the same time, depending on an operation, the first objects may be closely arranged or overlapped, or the second objects extending toward the first objects may be densely stacked or overlapped. In this case, it may be difficult for the respective users to identify objects corresponding to the first objects corresponding to their hands. Further, there are cases in which it is difficult to perform the operation on the operation target in the screen displayed in the display region 41 in the first place due to the close arrangement or the overlap of the second objects.

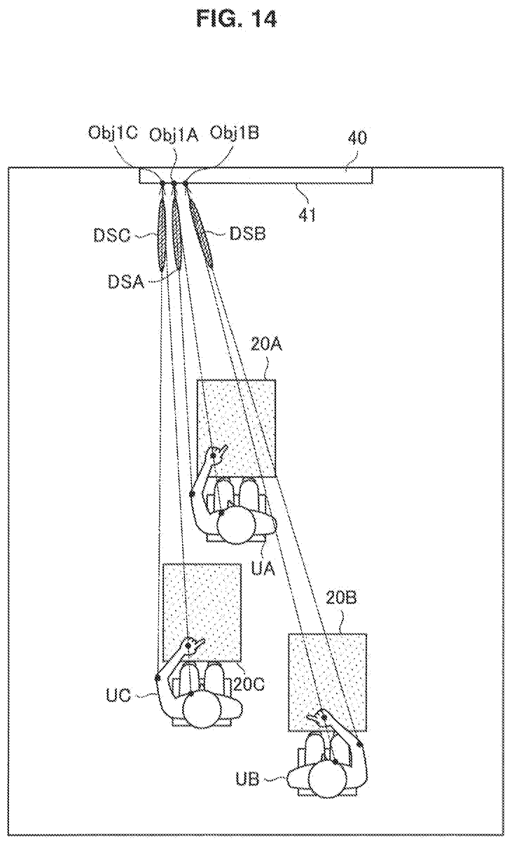

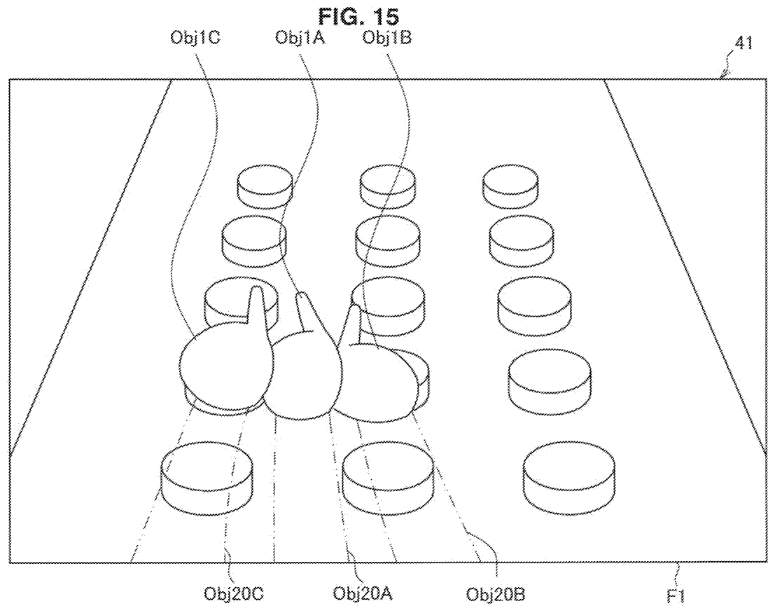

FIG. 14 is a diagram illustrating an example of a state in which a plurality of users is using the display control system 1A according to the present embodiment. As illustrated in FIG. 14, it is assumed that the users UA, UB, and UC are densely arranged for the display region 41, and in the display region 41, the first objects Obj1A, Obj1B, and Obj1C corresponding to the hands of the respective users are displayed at positions close to each other. The second display control unit 103 calculates display positions Obj20A, Obj20B, and Obj20C of the second objects to be arranged as directions indicated by extension lines DSA, DSB, and DSC of the arms are projected onto the display region 41 on the basis of the viewpoint positions of the respective users UA, UB, and UC, the positions of the hands, and the positions of the upper limbs.

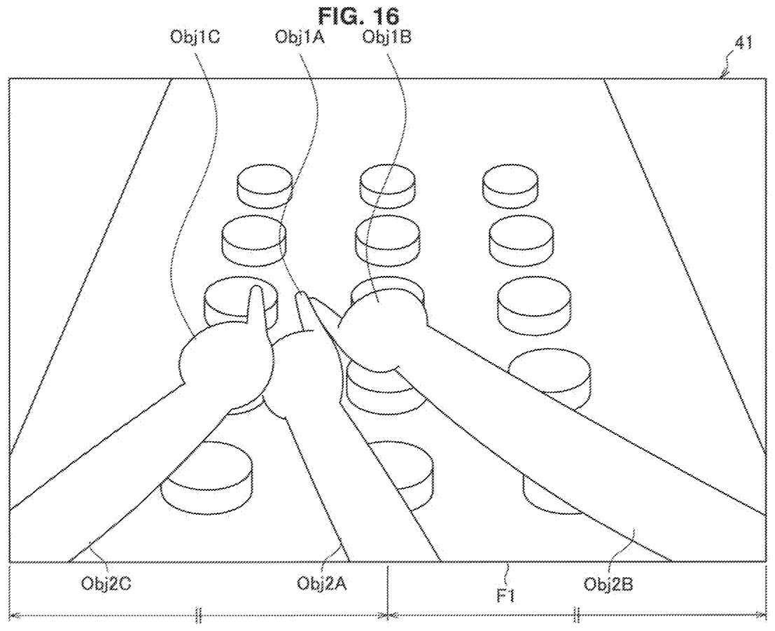

FIG. 15 is a diagram illustrating an example of a screen displayed in the display region 41 illustrated in FIG. 14. As illustrated in FIG. 15, the first objects Obj1A, Obj1B, and Obj1C respectively corresponding to the users UA, UB, and UC are closely arranged. In this case, the display positions Obj20A, Obj20B, Obj20C of the second objects can also be closely arranged. In practice, if the second objects are displayed at display positions illustrated in FIG. 15, it is not easy to identify the second object corresponding to his/her arm, and it is also difficult to identify the first object. Further, since the display positions of the second objects are close, display of content in a region nearby such a display position can be hindered.

In this regard, the second display control unit 103 according to the present embodiment can control the display of the second object on the basis of a positional relation of a plurality of users. Accordingly, there is no confusion between the operation objects, and it is also possible to prevent inhibition of display of contents.

The second display control unit 103 may control the display position of the second object, for example, on the basis of a positional relation of a plurality of users.

FIG. 16 is a diagram illustrating a first example of control of the display positions of a plurality of objects by the second display control unit 103. Referring to FIG. 14, the users UA, UB, and UC are arranged toward the display region 41 in the order of the users UC, UA, and UB. Therefore, as illustrated in FIG. 16, the second display control unit 103 performs display such that the second object Obj2C is arranged from the left end of the contour F1 in the lower part of the display region 41 to the display position of the first object Obj1C. Similarly, the second display control unit 103 performs display such that the second object Obj2B is arranged from the right end of the contour F1 to the display position of the first object Obj1B. Further, the second display control unit 103 performs display such that the second object Obj2A is arranged from the central portion of the contour F1 to the display position of the first object Obj1A. Accordingly, since the second objects are displayed with intervals while corresponding to the positions of the users, the confusion between the operation objects can be prevented.

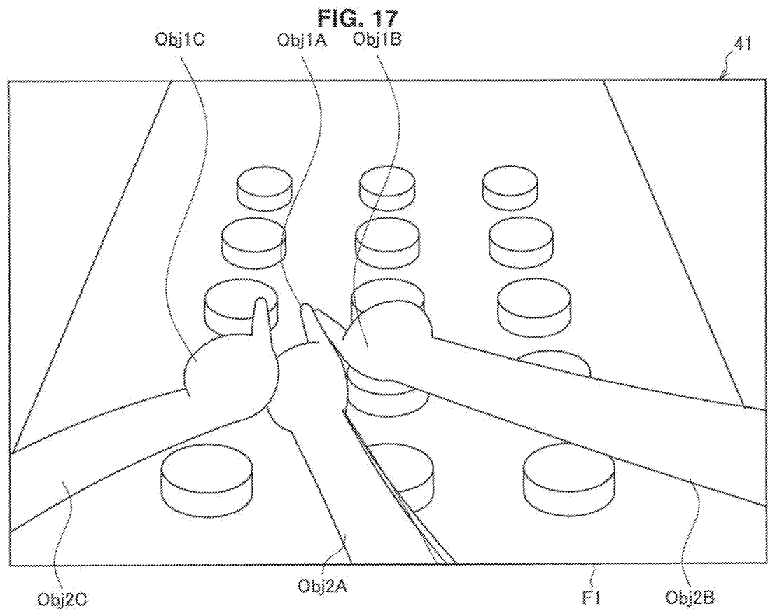

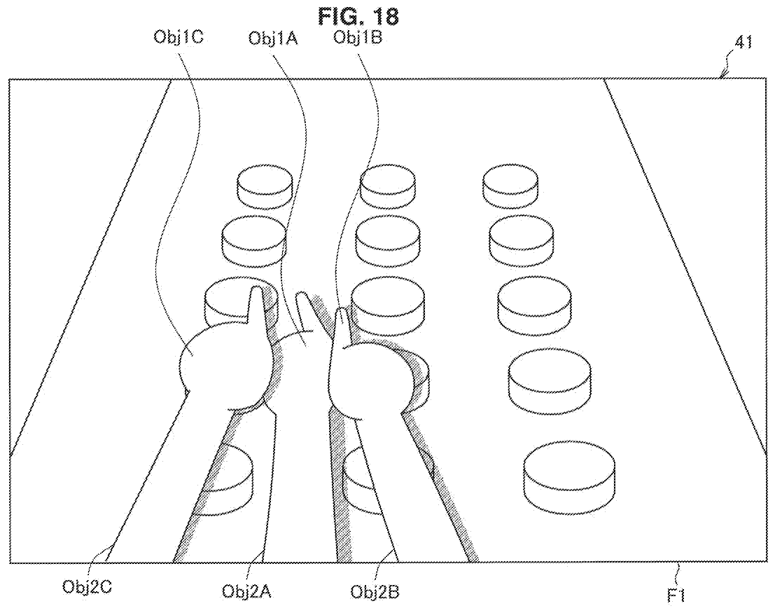

Further, in the example illustrated in FIG. 16, the second objects Obj2A to Obj2C are arranged from equally spaced points of the contour F1 toward the first objects Obj1A to Obj1C, respectively, but the present technology is not limited to this example. FIG. 17 is a diagram illustrating a second example of control of the display positions of a plurality of objects by the second display control unit 103. In the example illustrated in FIG. 17, the second object Obj2B is arranged to extend from a contour F2 on the right side of the display region 41, and the second object Obj2C is arranged to extend from a contour F3 on the left side of the display region 41. When the second objects are arranged as illustrated in FIG. 17, it is possible to more easily identify the operation object corresponding to his/her hand.

Further, the present technology is not limited to the examples illustrated in FIGS. 16 and 17, and as long as control is performed on the basis of a positional relation of the users such that the display positions of the second objects are not close to each other, specific display positions thereof are not particularly limited. For example, the second object may be displayed to extend from at least one contour among the upper and lower contours and the left and right contours of the display region 41 on the basis of the positional relation of the users. Further, the display intervals of the adjacent second objects are not particularly limited and can be adjusted to the extent that the user can identify the first object corresponding to his/her hand, and the operability for the operation target is not lowered.

Further, the “positional relation of the users” in the present disclosure may include, for example, an arrangement of the users for the display region 41. As described above, the second display control unit 103 may control the display of the second object on the basis of the arrangement of a plurality of users for the display region 41. This arrangement may be an arrangement in a direction parallel to the plane of the display region 41 as illustrated in the example of FIG. 16 or may be an arrangement in a depth direction with respect to the display region 41. Such an arrangement may be estimated, for example, by a position of the operating body detecting device 20 or by positions of a plurality of users detected by the object detecting device 30.

For example, in a case in which the users are arranged in the depth direction with respect to the display region 41, and the first objects corresponding to the users are displayed close to each other, the second objects may also be closely arranged or overlapped. Therefore, in a case in which a plurality of users is arranged in the depth direction with respect to the display region 41, the second display control unit 103 may appropriately adjusts the display positions or the like of the second objects on the basis of the display positions or the like of the first objects. For example, as will be described later, the second display control unit 103 may adjust a height of the second object in the VR space and an inclination angle of the second object in accordance with a distance between the display region 41 and each user. Accordingly, although the second objects corresponding to the users are closely arranged or overlapped on the plane of the display region 41, the user can identify the second object corresponding to him/herself.

Further, the “positional relation of the users” may include, for example, the density of the users. In other words, the second display control unit 103 may control the display of the second objects on the basis of the density of the users. The density of the users means, for example, the number of users who are located in a region of a predetermined size.

For example, in a case in which the density of the users is high, it is considered that the second objects are also likely to be closely arranged. In this regard, the second display control unit 103 may control the display positions of the second objects corresponding to the users belonging to a group in which the density of the users is high. Accordingly, it is possible to eliminate the close arrangement of the second objects and prevent confusion between the first objects corresponding to the hands of the users. The density of the users may be estimated, for example, on the basis of a position of the operating body detecting device 20 or may be estimated by positions of a plurality of users detected by the object detecting device 30.

Further, in the example illustrated in FIG. 15, the first objects Obj1A to Obj1C are closely arranged. In this case, the display positions Obj20A to Obj20C of the second objects arranged to face the display positions of the first objects Obj1A to Obj1C may also be closely arranged. Therefore, the second display control unit 103 may control the display of the second objects on the basis of the density of the first objects. For example, in a case in which a plurality of first objects are closely arranged in the vicinity of a predetermined display position, the second display control unit 103 may control the display position of the second objects such that the second objects are not close to each other as illustrated in FIG. 16. Accordingly, it is possible to eliminate the close arrangement of the second objects and prevent confusion between the first objects corresponding to the hands of the users.

Further, the second display control unit 103 may control the display form of the second objects, for example, on the basis of the positional relation of a plurality of users. Here, the display form can include, for example, the size and the shape of display of the operation object, the height in the VR space, the display effect (including a sequential change or the like), and the like as described in the first embodiment.

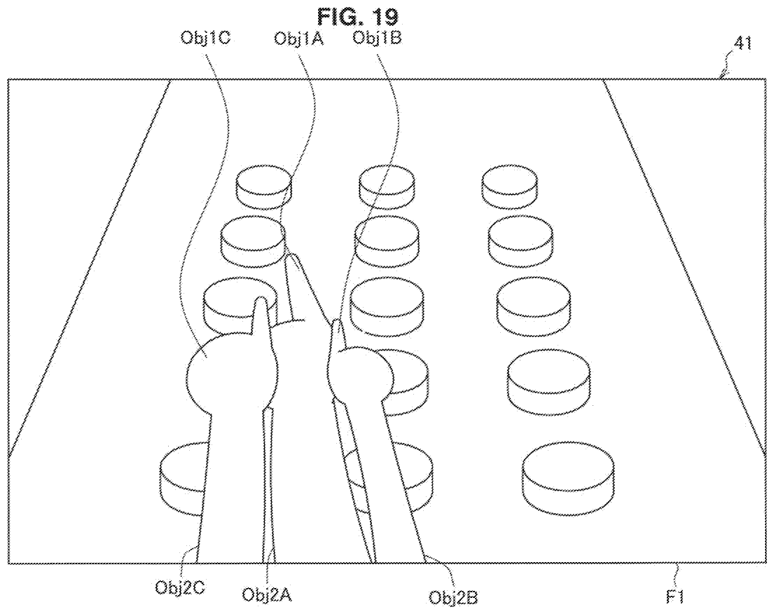

FIG. 18 is a diagram illustrating a first example of control of the display form of a plurality of objects by the second display control unit 103. Further, respective objects illustrated in FIG. 18 are objects displayed on the basis of the operations of the users UA to UC illustrated in FIG. 14. As illustrated in FIG. 18, the first objects Obj1A to Obj1C are closely arranged, and the second objects Obj2A to Obj2C are closely arranged accordingly. Therefore, it is difficult for each user to identify the first object corresponding to his/her hand among the first objects Obj1A to Obj1C.

In this regard, the second display control unit 103 may control the heights of the second object Obj2A to Obj2C in the VR space displayed in the display region 41 on the basis of the positional relation of the users. For example, as illustrated in FIG. 18, the second display control unit 103 may control the heights of the second objects Obj2A to Obj2C in accordance with the distance between the display region 41 and each user. More specifically, the second display control unit 103 may decrease the height of the second object corresponding to the user close to the display region 41, increase the height of the second object corresponding to the user far from the display region 41. Accordingly, even when the operation objects are closely displayed, it is possible to intuitively understand the operation objects corresponding to their hands.

Further, in the example illustrated in FIG. 18, in addition to the height of the second object, the height of the first object can be controlled as well. Further, in the example illustrated in FIG. 18, the heights of all the operation objects in the VR space are controlled to be a predetermined height, but a corresponding operation object may be inclined so that the first object is grounded on the bottom surface of the VR space. Accordingly, for example, the display of the operation on the operation target arranged on the bottom surface becomes more comfortable. In this case, as described above, for example, the inclination angle can be controlled in accordance with the distance between the display region 41 and each user.

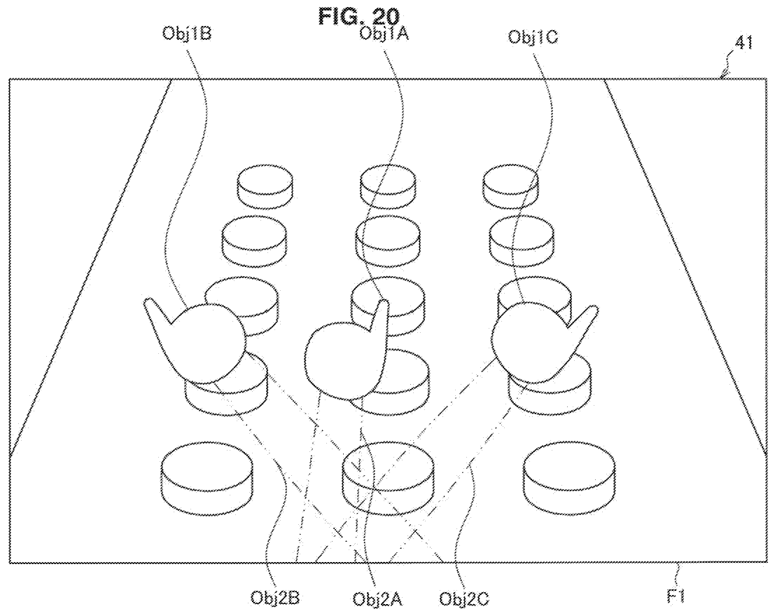

FIG. 19 is a diagram illustrating a second example of control of the display form of a plurality of objects by the second display control unit 103. Further, respective objects illustrated in FIG. 19 are objects displayed on the basis of the operations of the users UA to UC illustrated in FIG. 14. As illustrated in FIG. 19, the first objects Obj1A to Obj1C are closely arranged, and the second objects Obj2A to Obj2C are closely arranged accordingly. Therefore, it is difficult for each user to identify the first object corresponding to his/her hand among the first objects Obj1A to Obj1C.

In this regard, the second display control unit 103 may control the sizes of the second object Obj2A to Obj2C on the basis of the positional relation of the users. For example, as illustrated in FIG. 19, the second display control unit 103 may control the sizes of the second objects Obj2A to Obj2C in accordance with the distance between the display region 41 and each user. More specifically, the second display control unit 103 may decrease the size of the second object corresponding to the user close to the display region 41, increase the size of the second object corresponding to the user far from the display region 41. Accordingly, even when the operation objects are closely displayed, it is possible to intuitively understand the operation objects corresponding to their hands.

Further, for the size of the second object, the second object corresponding to the user closer to the display region 41 may be larger, and the second object corresponding to the user far from the display region 41 may be smaller. Here, in consideration of the consistency with the control of the size of the first object based on the relation of the viewpoint position of the user, the position of the hand, and the position of the display region 41, it is desirable to perform control such that the size of the second object be increased with the increase in the distance between the display region 41 and the user.

FIG. 20 is a diagram illustrating a third example of control of the display form of a plurality of objects by the second display control unit 103. Further, respective objects illustrated in FIG. 20 are objects displayed on the basis of the operations of the users UA to UC illustrated in FIG. 14. As illustrated in FIG. 20, the second objects Obj2A to Obj2C are displayed in a state in which they intersect with each other. In this case, the display of the content at the intersecting positions is shielded by the second objects Obj2A to Obj2C.

In this regard, the second display control unit 103 may perform control such that the display of the second objects Obj2A to Obj2C intersecting with each other is transparent. In this case, for example, the second display control unit 103 may cause the second objects Obj2A to Obj2C to be transparent after causing the second objects Obj2A to Obj2C to be displayed without change for a certain period of time. Accordingly, it is possible to intuitively recognize the first objects Obj1A to Obj1C corresponding to the hands of the users, and it is possible to prevent display of content from being hindered. In the case of causing the second objects Obj2A to Obj2C to be transparent after a certain period of time elapses, the second display control unit 103 may cause the second objects Obj2A to Obj2C to become transparent instantaneously or may cause the second objects Obj2A to Obj2C to become transparent gradually over a predetermined period of time.

Further, in the example illustrated in FIG. 20, the second objects are caused to be transparent, but the first display control unit 102 may cause only the first objects to be transparent. The operation target of the content displayed in the display region 41 can be operated by the first object. Therefore, since only the first objects are caused to be transparent, it is possible to intuitively recognize the first objects, and it is possible to cause the operability for the operation target not to be lowered.

Further, in a case in which a plurality of second objects are displayed in a superimposed manner, the second display control unit 103 may cause a second object serving as an upper layer to be transparent. Accordingly, since a second object serving as a lower layer is displayed, it is possible to prevent the operability of the user corresponding to the second object from being lowered.

The display control examples for the second object based on the positional relation between a plurality of users by the second display control unit 103 according to the present embodiment have been described above. Further, the examples illustrated in FIGS. 16 to 20 are examples of the display control based on the positional relation of a plurality of users, but the present technology is not limited to such examples. For example, the second display control unit 103 may control the display position and the display form of the second object irrespective of the positional relation of a plurality of users.

### 3. Hardware Configuration Example

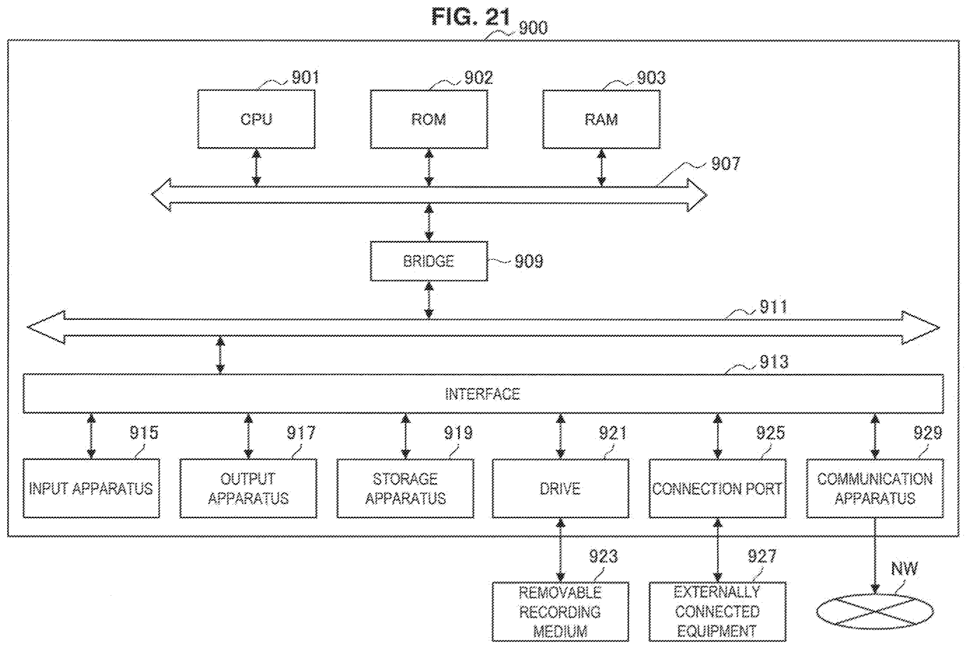

Next, the hardware configuration of an information processing apparatus 900 according to an embodiment of the present disclosure is described with reference to FIG. 21. FIG. 21 is a block diagram illustrating a hardware configuration example of the information processing apparatus 900 according to an embodiment of the present disclosure. The illustrated information processing apparatus 900 may realize the display control apparatus in the foregoing embodiment, for example.

The information processing apparatus 900 includes a central processing unit (CPU) 901, read-only memory (ROM) 903, and random-access memory (RAM) 905. In addition, the information processing apparatus 900 may include a host bus 907, a bridge 909, an external bus 911, an interface 913, an input apparatus 915, an output apparatus 917, a storage apparatus 919, a drive 921, a connection port 925, and a communication apparatus 929. In conjunction with, or in place of, the CPU 901, the information processing apparatus 900 may have a processing circuit called a digital signal processor (DSP) or application specific integrated circuit (ASIC).

The CPU 901 functions as an arithmetic processing unit and a control unit, and controls the whole operation in the information processing apparatus 900 or a part thereof in accordance with various programs recorded in the ROM 903, the RAM 905, the storage apparatus 919, or a removable recording medium 923. The ROM 903 stores programs, operation parameters, or the like used by the CPU 901. The RAM 905 temporarily stores programs used in the execution by the CPU 901, parameters that vary as appropriate in the execution, or the like. For example, the CPU 901, the ROM 903, and the RAM 905 may realize the functions of the control unit 100 in the foregoing embodiment. The CPU 901, the ROM 903, and the RAM 905 are connected with each other via the host bus 907 that includes an internal bus such as a CPU bus. Furthermore, the host bus 907 is connected to the external bus 911 such as peripheral component interconnect/interface (PCI) bus via the bridge 909.

The input apparatus 915 is, in one example, an apparatus operated by a user, such as a mouse, a keyboard, a touch panel, a button, a switch, and a lever. The input apparatus 915 may be, in one example, a remote control apparatus using infrared rays or other radio waves, or may be externally connected equipment 927 such as a cellular phone that supports the operation of the information processing apparatus 900. The input apparatus 915 includes an input control circuit that generates an input signal on the basis of the information input by the user and outputs it to the CPU 901. The user operates the input apparatus 915 to input various data to the information processing apparatus 900 and to instruct the information processing apparatus 900 to perform a processing operation.

The output apparatus 917 includes an apparatus capable of notifying visually or audibly the user of the acquired information. The output apparatus 917 may be a display apparatus such as a liquid crystal display (LCD), a plasma display panel (PDP), and an organic electro-luminescence display (OELD), an audio output apparatus such as a speaker and a headphone, as well as printer apparatus or the like. The output apparatus 917 outputs the result obtained by the processing of the information processing apparatus 900 as a video such as a text or an image, or outputs it as audio such as a speech or sound.

The storage apparatus 919 is a data storage apparatus configured as an example of a storage portion of the information processing apparatus 900. The storage apparatus 919 includes, in one example, a magnetic storage unit device such as hard disk drive (HDD), a semiconductor storage device, an optical storage device, and a magneto-optical storage device. The storage apparatus 919 stores programs executed by the CPU 901, various data, various types of data obtained from the outside, and the like.

The drive 921 is a reader-writer for a removable recording medium 923 such as a magnetic disk, an optical disk, a magneto-optical disk, and a semiconductor memory, and is incorporated in the information processing apparatus 900 or externally attached thereto. The drive 921 reads the information recorded on the loaded removable recording medium 923 and outputs it to the RAM 905. In addition, the drive 921 writes a record in the loaded removable recording medium 923. At least one of the storage apparatus 919, or the drive 921 and the removable recording medium 923 may realize the functions of the storage unit 120 in the foregoing embodiment.

The connection port 925 is a port for directly connecting equipment to the information processing apparatus 900. The connection port 925 may be, in one example, a Universal Serial Bus (USB) port, an IEEE 1394 port, or a Small Computer Device Interface (SCSI) port. In addition, the connection port 925 may be, in one example, an RS-232C port, an optical audio terminal, or High-Definition Multimedia Interface (HDMI, registered trademark) port. The connection of the externally connected equipment 927 to the connection port 925 makes it possible to exchange various kinds of data between the information processing apparatus 900 and the externally connected equipment 927.

The communication apparatus 929 is, in one example, a communication interface including a communication device or the like, which is used to be connected to the communication network NW. The communication apparatus 929 may be, in one example, a communication card for wired or wireless local area network (LAN), Bluetooth (registered trademark), or wireless USB (WUSB). In addition, the communication apparatus 929 may be, in one example, a router for optical communication, a router for asymmetric digital subscriber line (ADSL), or a modem for various communications. The communication apparatus 929 transmits and receives signals or the like using a predetermined protocol such as TCP/IP, in one example, with the Internet or other communication equipment. In addition, the communication network NW connected to the communication apparatus 929 is a network connected by wire or wireless, and is, in one example, the Internet, home LAN, infrared communication, radio wave communication, satellite communication, or the like. Note that at least one of the connection port 925 and the communication apparatus 929 may realize the functions of the communication unit 110 in the foregoing embodiment.

The above illustrates one example of a hardware configuration of the information processing apparatus 900.

### 4. Conclusion

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, in the above embodiment, VR content using the VR space has been dealt as an application target of the present technology, but the present technology is not limited to this example. For example, the screen displayed in the display region may be a screen of an augmented reality (AR) space used for AR content or may be a screen displaying arbitrary video content such as a video game, a moving image, or a still image expressed by a two-dimensional video. Further, the screen displayed in the display region may be a screen realizing an interface or the like provided for an operation for using arbitrary content in addition to the above content. In other words, the present technology can be applied as long as an operation is performed on the screen displayed in the display region, and it is content, an interface, or the like in which an output to an operation is reflected on a screen.

Note that each of the steps in the processes of the display control apparatus in this specification is not necessarily required to be processed in a time series following the sequence described as a flowchart. For example, each of the steps in the processes of the display control apparatus may be processed in a sequence that differs from the sequence described herein as a flowchart, and furthermore may be processed in parallel.

Additionally, it is possible to create a computer program for causing hardware such as a CPU, ROM, and RAM built into a display control apparatus to exhibit functions similar to each component of the display control apparatus described above. In addition, a readable recording medium storing the computer program is also provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A display control apparatus, including:

a first display control unit configured to control display of a first object corresponding to an operating body in a display region on the basis of a position of the operating body and a viewpoint position of a user; and

a second display control unit configured to control display of a second object arranged toward a display position of the first object in the display region.

(2)

The display control apparatus according to (1), in which the second display control unit controls the display of the second object on the basis of a position of the user in a space in which the display region is installed.

(3)

The display control apparatus according to (2), in which the second object is an object corresponding to a supporting body which is associated with the user and supports the operating body, and

the control of the display of the second object includes control of the display of the second object based on a position of the supporting body.

(4)

The display control apparatus according to (3), in which the second display control unit controls the display of the second object on the basis of a relation between a display position of the first object in the display region and the position of the supporting body.

(5)

The display control apparatus according to (3) or (4), in which the position of the supporting body is estimated on the basis of information obtained by detecting a skeleton of the user.

(6)

The display control apparatus according to any one of (2) to (5), in which the position of the user in the space is identical to the position of the operating body.

(7)

The display control apparatus according to any one of (2) to (6), in which the second display control unit controls the display of the second object on the basis of a positional relation of a plurality of the users.

(8)

The display control apparatus according to (7), in which the positional relation of the plurality of the users includes a density of the users.

(9)

The display control apparatus according to (7) or (8), in which the positional relation of the plurality of the users includes an arrangement of the users.

(10)

The display control apparatus according to any one of (1) to (9), in which the second display control unit controls the display of the second object on the basis of a density of the first object.

(11)

The display control apparatus according to any one of (1) to (10), in which the control of the display of the second object includes control of a display position of the second object.

(12)

The display control apparatus according to any one of (1) to (11), in which the control of the display of the second object includes control of a display form of the second object.

(13)

The display control apparatus according to (12), in which the control of the display form of the second object includes control of a height of the second object in a virtual space displayed in the display region.

(14)

The display control apparatus according to (12) or (13), in which the control of the display form of the second object includes control of a size of the second object.

(15)

The display control apparatus according to any one of (1) to (14), in which the second object is displayed to extend from a contour of the display region.

(16)

The display control apparatus according to any one of (1) to (15), in which the viewpoint position of the user is estimated on the basis of information obtained by detecting a skeleton of the user.

(17)

The display control apparatus according to any one of (1) to (16), in which the first display control unit controls a size of the first object on the basis of a relation of the viewpoint position of the user, the position of the operating body, and a position of the display region.

(18)

The display control apparatus according to any one of (1) to (17), in which a screen related to a virtual reality (VR) space is displayed in the display region, and the display of the screen is controlled on the basis of the position of the operating body and the viewpoint position of the user.

(19)

A display control method, including: controlling, by a processor, display of a first object corresponding to an operating body in a display region on the basis of a position of the operating body and a viewpoint position of a user; and

controlling, by the processor, display of a second object arranged toward a display position of the first object in the display region.

(20)

A program causing a computer to function as:

a first display control unit configured to control display of a first object corresponding to an operating body in a display region on the basis of a position of the operating body and a viewpoint position of a user; and

a second display control unit configured to control display of a second object arranged toward a display position of the first object in the display region.

### REFERENCE SIGNS LIST

1, 1A display control system
10 display control apparatus
20 operating body detecting device
30 object detecting device
40 display device
41 display region
100 control unit
101 acquiring unit
102 first display control unit
103 second display control unit
110 communication unit
120 storage unit

1. A display control apparatus, comprising:
a first display control unit configured to control display of a first object corresponding to an operating body in a display region on a basis of a position of the operating body and a viewpoint position of a user; and
a second display control unit configured to control display of a second object arranged toward a display position of the first object in the display region.

2. The display control apparatus according to claim 1, wherein the second display control unit controls the display of the second object on a basis of a position of the user in a space in which the display region is installed.

3. The display control apparatus according to claim 2, wherein the second object is an object corresponding to a supporting body which is associated with the user and supports the operating body, and
the control of the display of the second object includes control of the display of the second object based on a position of the supporting body.

4. The display control apparatus according to claim 3, wherein the second display control unit controls the display of the second object on a basis of a relation between a display position of the first object in the display region and the position of the supporting body.

5. The display control apparatus according to claim 3, wherein the position of the supporting body is estimated on a basis of information obtained by detecting a skeleton of the user.

6. The display control apparatus according to claim 2, wherein the position of the user in the space is identical to the position of the operating body.

7. The display control apparatus according to claim 2, wherein the second display control unit controls the display of the second object on a basis of a positional relation of a plurality of the users.

8. The display control apparatus according to claim 7, wherein the positional relation of the plurality of the users includes a density of the users.

9. The display control apparatus according to claim 7, wherein the positional relation of the plurality of the users includes an arrangement of the users.

10. The display control apparatus according to claim 1, wherein the second display control unit controls the display of the second object on a basis of a density of the first object.

11. The display control apparatus according to claim 1, wherein the control of the display of the second object includes control of a display position of the second object.

12. The display control apparatus according to claim 1, wherein the control of the display of the second object includes control of a display form of the second object.

13. The display control apparatus according to claim 12, wherein the control of the display form of the second object includes control of a height of the second object in a virtual space displayed in the display region.

14. The display control apparatus according to claim 12, wherein the control of the display form of the second object includes control of a size of the second object.

15. The display control apparatus according to claim 1, wherein the second object is displayed to extend from a contour of the display region.

16. The display control apparatus according to claim 1, wherein the viewpoint position of the user is estimated on a basis of information obtained by detecting a skeleton of the user.

17. The display control apparatus according to claim 1, wherein the first display control unit controls a size of the first object on a basis of a relation of the viewpoint position of the user, the position of the operating body, and a position of the display region.

18. The display control apparatus according to claim 1, wherein a screen related to a virtual reality (VR) space is displayed in the display region, and
the display of the screen is controlled on the basis of the position of the operating body and the viewpoint position of the user.

19. A display control method, comprising:
controlling, by a processor, display of a first object corresponding to an operating body in a display region on a basis of a position of the operating body and a viewpoint position of a user; and
controlling, by the processor, display of a second object arranged toward a display position of the first object in the display region.

20. A program causing a computer to function as:
a first display control unit configured to control display of a first object corresponding to an operating body in a display region on a basis of a position of the operating body and a viewpoint position of a user; and
a second display control unit configured to control display of a second object arranged toward a display position of the first object in the display region.
